(19) United States
(12) Patent Application Publication
(10) Pub. No.: US 2017/0199968 A1
(43) Pub. Date: Jul. 13, 2017

(54) EVIDENCE-BASED COMPREHENSIVE POPULATION HEALTH MANAGEMENT INFORMATION COLLECTION, AGGREGATION, ANALYTIC AND REPORTING SYSTEM

(71) Applicant: Michael Vincent Smith, Atlanta, GA (US)

(72) Inventor: Michael Vincent Smith, Atlanta, GA (US)

(21) Appl. No.: 15/385,013

(22) Filed: Dec. 20, 2016

Related U.S. Application Data
(60) Provisional application No. 62/276,062, filed on Jan. 7, 2016.

(51) Int. Cl. G06F 19/00; G06Q 10/10

(52) U.S. Cl. CPC G06F 19/325; G06Q 10/1093

(57) ABSTRACT

A population health management system comprises a device that comprises a circular base with a center and an outer diameter radially distal from the center; the base includes indicia including a first criteria set located on the base in a first region; the first criteria set comprises discrete health management actionable topics spaced concentrically apart in the first region; a second criteria set is concentrically located on the base in a second region radially outward from the first region, the second criteria comprises quarterly calendar sets spaced concentrically apart as quarters in the second region; a third criteria set concentrically located on the base in a third region radially outward from the second region and proximate the outer diameter, the third criteria set comprises a plurality of symbols; a circular rotary mask is configured to conceal and reveal a portion of the indicia responsive to rotation of the rotary mask.

### CROSS REFERENCE TO RELATED APPLICATIONS

This application claims priority to U.S. Patent Application Ser. No. 62/276,062, filed Jan. 7, 2016 and which is also incorporated herein by reference.

### BACKGROUND

The present disclosure is directed to the system that collects data from multiple sources in a format that allows the application of evidence-based algorithms, reports on burden of illness, gaps in care, stratifies populations for effective and efficient management and predicts high resource utilizing individuals and tracks outcomes. The system utilizes a device that organizes a set of input data categories related to the management and prediction of the high resource utilizing individuals. The device can be employed to inform individuals, providers and payers of best practices based on outcomes.

Successful population health management requires the optimal collection, storage, analysis, reporting and utilization of information that drives proactive identification and documentation of burden of illness, closure of all known gaps in care and resource allocation to reduce avoidable episodes of treatment across the continuum of health management. The volume of care delivery entities failing to meet the quality and performance metrics in accountable care programs is due, in part, to the fragmentation of information exchange first within the care management community, secondly between the individuals being cared for and the providers of care and last between the care delivery systems and the payer.

The Fragmented data collection, aggregation, analysis, reporting and utilization produces ineffective and inefficient population health management results in overutilization of many services, underutilization of others, increased medical errors, fraud, waste, abuse as well as avoidable administrative and financial burden to the health care system.

The prevention, proactive intervention aspect and complexity of population health management, in contrast to the request-for-services or products triggered managed care elements of prior authorization, concurrent review, case management, demand management and specialty case management require a level of information management and a timeliness and order of activities that are difficult to achieve without sophisticated process automation tools.

The technical advances and reduced costs of data analytics and storage coupled with the increasing challenge around information security, interoperability and usability make the case for an Accountable-Care-Network wide information collection, storage, analytics, and reporting platform (a shared service utility) that drives the effectiveness and efficiency of the clinical, operational and financial structure, processes and outcomes of the entity.

Because legacy health information management systems lack a repository of health determinant data requisite for population health management (medical, behavioral, functional, social, environmental and economic) the perceived value of building on these existing platforms is illusionary and the perceived value of adoption of superior systems in undervalued.

While many systems capture elements of the data sets needed for population health care management none have aggregated the disparate information in a single repository that then applied up to date evidence-based rules to analyze opportunities for optimal clinical, operational and financial management across the continuum of care (inpatient and outpatient, acute and chronic, medical, behavioral, functional, socioeconomic health care).

### SUMMARY

In accordance with the present disclosure, there is provided a population health management system comprises a device that comprises a circular base with a center and an outer diameter radially distal from the center; the base includes indicia including a first criteria set located on the base in a first region; the first criteria set comprises discrete health management actionable topics spaced concentrically apart in the first region; a second criteria set is concentrically located on the base in a second region radially outward from the first region, the second criteria comprises quarterly calendar sets spaced concentrically apart as quarters in the second region; a third criteria set concentrically located on the base in a third region radially outward from the second region and proximate the outer diameter, the third criteria set comprises a plurality of symbols; a circular rotary mask is configured to conceal and reveal a portion of the indicia responsive to rotation of the rotary mask.

In another and alternative embodiment, the mechanical process automation device comprises a scheduling wheel chart.

In another and alternative embodiment, the discrete health management actionable topics comprise at least one of evaluation, education, empowerment, extremes, engagement, and enrollment.

In another and alternative embodiment, the evaluation is based on the collection of structured and non-structured clinical, behavioral, functional, pharmaceutical, socioeconomic, utilization and resource allocation data.

In another and alternative embodiment, the quarterly calendar sets comprise a first quarter of a year, a second quarter of the year, a third quarter of the year and a fourth quarter of the year.

In another and alternative embodiment, the plurality of population health information data symbols represent population health information selected from the group consisting of burden of illness, gap in care closure, plan of care completion, member attribution update and the like.

In another and alternative embodiment, the mechanical process automation device is configured to guide a user to systematically chronologically implement the health management system to deliver health care to a population enrolled within the health management system.

In accordance with the present disclosure, there is provided a process for utilizing a population health management mechanical process automation device, the process comprising revealing indicia concentrically located on a circular base of the mechanical process automation device, the base having a center and an outer diameter radially distal from the center; the indicia including at least one criteria set; rotating a circular rotary mask coupled to the base and configured to rotate about the center; concealing a portion of the indicia responsive to rotation of the rotary mask; revealing a portion of the indicia responsive to rotation of the rotary mask; collecting data related to a first criteria set concentrically located on the base in a first region proximate the center, the collecting data step being initiated based on a second criteria set concentrically located on the base in a second region radially outward from the first region; and collecting data related to a third criteria set concentrically located on the base in a third region radially outward from the second region and proximate the outer diameter.

In another and alternative embodiment, the first criteria set comprises discrete health management actionable topics spaced concentrically apart in the first region of the base.

In another and alternative embodiment, the discrete health management actionable topics comprise at least one of evaluation, education, empowerment, extremes, engagement, and enrollment.

In another and alternative embodiment, the second criteria comprises quarterly calendar sets spaced concentrically apart as quarters in the second region.

In another and alternative embodiment, the quarterly calendar sets comprise a first quarter of a year, a second quarter of the year, a third quarter of the year and a fourth quarter of the year.

In another and alternative embodiment, the third criteria set comprises a plurality of population health information data symbols.

In another and alternative embodiment, the plurality of population health information data symbols represent population health information selected from the group consisting of burden of illness, gap in care closure, plan of care completion, member attribution update and the like.

In another and alternative embodiment, the process further comprises guiding a user to systematically chronologically implement the health management system to deliver health care to a population enrolled within the health management system.

In another and alternative embodiment, the process further comprises employing a health assessment data template to collect data related to the discrete health management actionable topics.

In another and alternative embodiment, the health assessment data template includes inquiries with corresponding answers to the inquiries.

In another and alternative embodiment, the process further comprises assessing the answers utilizing a color code rank value assigned to the answers, wherein the color code rank value provides a visual cue for the assessment data template.

In another and alternative embodiment, the process further comprises converting the color code rank value into numerical values; and converting the numerical values into a graphic format.

In another and alternative embodiment, the graphic format comprises a spider graph.

Other details of the population health management system are set forth in the following detailed description and the accompanying drawing wherein like reference numerals depict like elements.

### BRIEF DESCRIPTION OF THE DRAWINGS

FIG. 1 is a schematic of an exemplary population health management system device;

FIG. 2 is a partial schematic of an exemplary population health management system device;

FIG. 3 is a schematic diagram of an exemplary clinical determinant of health assessment;

FIG. 4 is a spider graph of an of an exemplary member determinant of health profile;

FIG. 5 is top view of an exemplary population health management system device base;

FIG. 6 is side view of an exemplary population health management system device base;

FIG. 7 is a top view of an exemplary population health management system device with base and rotary sheet;

FIG. 8 is a side view of an exemplary population health management system device with base and rotary sheet;

FIG. 9 is a top view of an exemplary population health management system device with base and rotary sheets;

FIG. 10 is a side view of an exemplary population health management system device with base and rotary sheets;

FIG. 11 is a top view of an exemplary population health management system device with base, rotary sheets and rotary mask;

FIG. 12 is a side view of an exemplary population health management system device with base, rotary sheets and rotary mask

FIG. 13 is a top view of a spider graph on a sheet of an of an exemplary member determinant of health profile;

FIG. 14 is a side view of a spider graph sheet of an of an exemplary member determinant of health profile;

FIG. 15 shows multiple spider graphs on a sheet of exemplary member determinant of health profiles.

### DETAILED DESCRIPTION

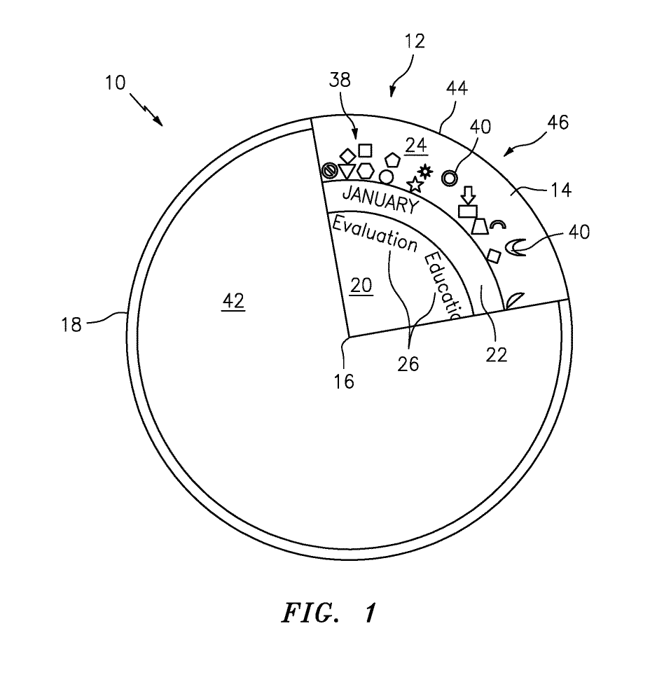

Referring now to FIG. 1, there is illustrated an exemplary population health management system 10. The exemplary population health management system 10 includes a mechanical process automation device 12, such as a scheduling wheel chart. The mechanical process automation device 12 includes a base 14. The base 14 can be configured as a planar circular disc. The base 14 includes a center 16 and an outer diameter 18. The center 16 is located at the center of the circular shape. The outer diameter 18 is formed around the perimeter of the circular shape. The base 14 includes a first region 20 proximate the center 16. The base 14 includes a second region 22 adjacent said first region 20 located radially distal from said first region 20. A third region 24 of said base 14 is adjacent said second region 24 and is located proximate said outer diameter 18.

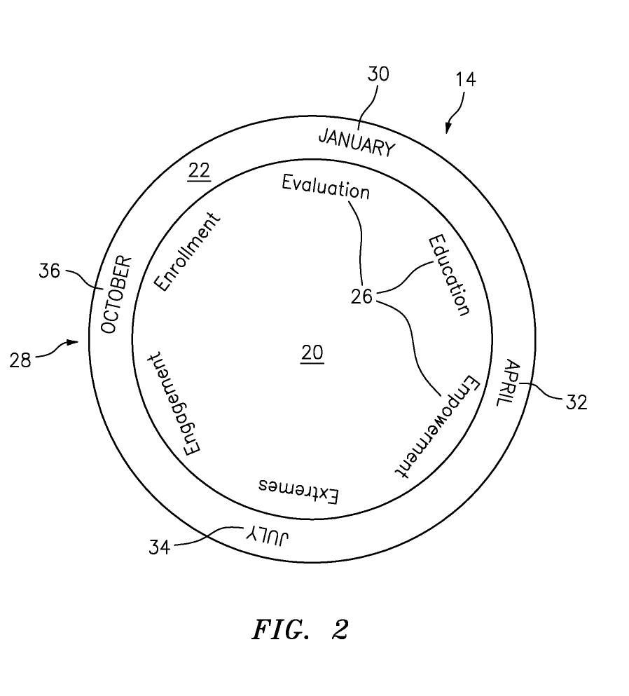

Referring also to FIG. 2, a first criteria set 26 appears on the base 14 in the first region 20. The first criteria set 26 can include discrete health management actionable topics space apart in a concentric fashion around the center 16 of the first region 20. The first criteria 26 can include evaluation (the collection of medical, behavioral, functional, socioeconomic and environment data), education (evidence based principles and practices provided to optimize awareness of best practices in the management of an individual member or population of members), empowerment (situation-specific evidence based actions designed, developed, implemented and monitored to process automate the requisite care management needs of a member or a population of members), extremes (a member or population of members identified as outliers based on an observed failure to meet specific outcomes after appropriate execution of evaluation, education and empowerment protocols), engagement (the outreach, by various means of communication, to a member or population of members), and enrollment (the voluntary consist given by a member or population of members to participate in the population health management). Evaluation can be based on the collection of structured or non-structured data that can include but that is not limited to: clinical behavioral, functional, pharmaceutical, socioeconomic, utilization, and resource allocation data.

A second criteria set 28 appears on the base 14 in the second region 22. The second criteria set 28 can include quarterly calendar sets space concentrically apart, as quarters of the yearly calendar. The second criteria set 28 can include a first quarter 30 designated as January, a second quarter 32 designated as April, a third quarter 34 designated as July, and a fourth quarter 36 designated as October. The second criteria set 28 can be employed to schedule activities within the population health management system 10.

A third criteria set 38 appears on the base 14 in the third region 24. The third criteria set 38 can include a plurality of population health information data symbols 40. The data symbols 40 represent examples of population health information data that can include but are not limited to, burden of illness, gap in care closure, plan of care completion, member attribution update, product development, current year utilization analysis, prior year utilization analysis, future year budget analysis, current year (Cost of Care) CoC analysis (a longitudinal evaluation of medical expenses) member satisfaction analysis, network analysis, member segmentation, provider continuing education, (Risk Adjustment Factor) RAF determination (the use of standardized algorithms to calculate the severity of illness of a member or population of members against benchmarked standards), Bid submission preparation, operational effectiveness and efficiency reporting, cost of care reporting, (Healthcare Effectiveness Data and Information Set) HEDIS submission preparation, operational metrics review, clinical metrics review, financial metrics review, performance goals review.

A rotary mask 42 is coupled to the base 14. The rotary mask 42 is configured rotate about the center 16. The rotary mask 42 has a circular shape similar to the shape of the base 14. The rotary mask 42 is configured to conceal a portion of indicia 44 on the base 14 that make up the first criteria set 26, second criteria set 28 and third criteria set 38. The rotary mask 42 is also configured to reveal a portion of the indicia 44 of the base 14. As the rotary mask 42 is rotated the portion of the indicia 44 revealed and concealed changes. In an exemplary embodiment, the rotary mask 42 can be configured with a window 46. The window 46 is a cutaway portion of the rotary mask 42 that reveals the indicia 44 of the base 14. The window 46 can be a quarter of the whole circular shape of the rotary mask 42, in a pie shaped wedge.

The system 10 is configured to drive the comprehensive collection of structured clinical, behavioral, functional, pharmaceutical, socioeconomic, utilization and resource allocation data from disparate sources. The disparate sources can include an individual patient, a caregiver, a health care provider, diagnostic facilities, care delivery systems, claims, and the like.

As an example, the system 10 can be used by a member that has joined a healthcare plan. The exemplary member can be a 72-year-old female member with a history of Hypertension. She hears about the Health Plan through advertisements. She is offered the opportunity to chat live with a plan associate who explains how the device 12 works and solicits member information to demonstrate the functionality, reliability and convenience of the device 12 in automated the member specific vital processes during the population health life cycle.

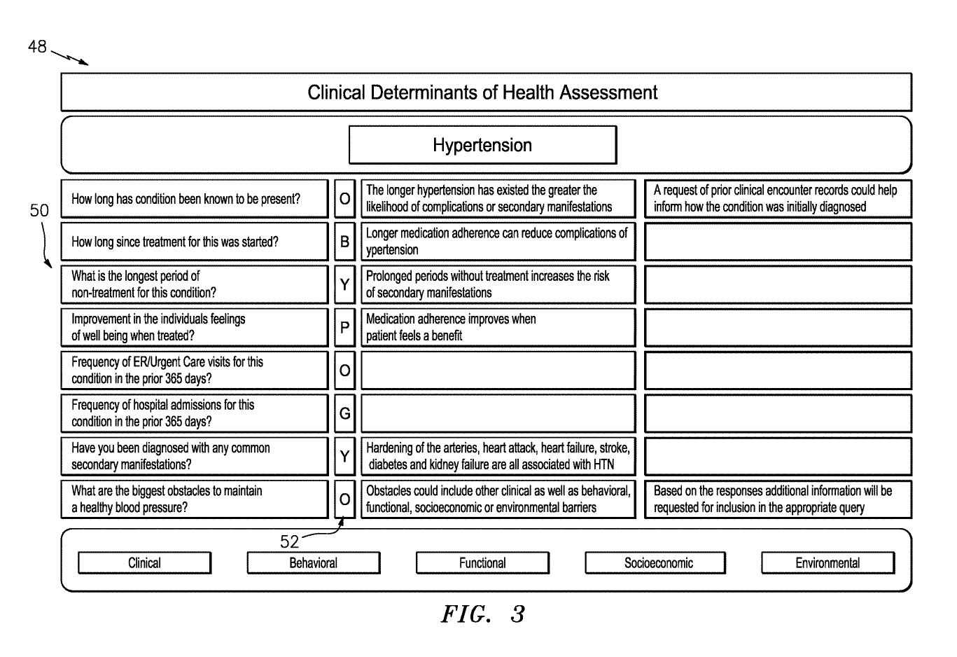

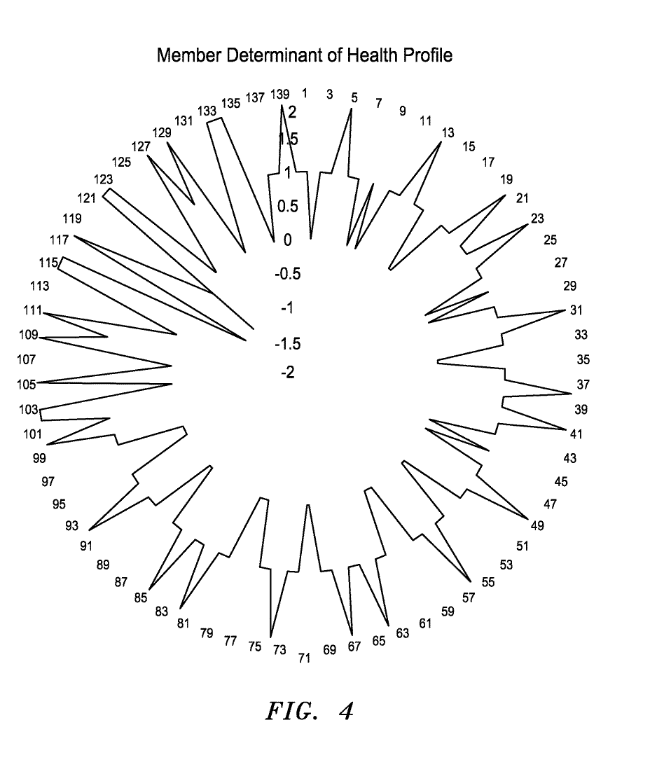

At about three months before the first quarter 30, the member selects a Health Plan during an Annual Enrollment Period. During the selection process a series of questions are presented to the member that allow the device 12 to input basic demographic information and customer preferences (such as provider characteristics, language preferences, best means of communication (telephone, online live engagement, web-based form completion with online tutorials), through designated caregiver, face to face encounter at physician's office or member's home, or even by mail. Additionally, a clinical determinant of health assessment is performed obtaining information regarding existing medical (in this case hypertension), behavioral, functional, social, environmental and economic demographics are provided by the member or a caregiver that has knowledge of the member. FIG. 3 illustrates an exemplary clinical determinant of health assessment data collection template (form) 48. The health assessment data collection template 48 includes inquiries 50 with corresponding answers to those inquires. A color code rank value 52. The color code rank value 52 can be used to assess the answers to the inquiries 50. The color code rank value 52 can also be converted into numerical values and converted to a graphic format as demonstrated at FIG. 4 in a spider graph.

The spider graph is based on the results captured from the determinants of health profile data form 48 (a modification of the CARE data form). The spider graph is as an example of how the information would be utilized. While an exemplary version of the determinants of health profile data form 48 can include in excess of 139 data points. The information for the determinants of health profile data form 48 will likely be collected over a period of sequential engagements and some of it provided by the member themselves. The determinants of health profile data form 48 can be gathered from a natural language interface that queries the member on the non-examination-required elements.

Referring to the spider graph at FIG. 4, the area under the curve should help identify high risk cohorts, the area in a given section (skin integrity) should provide insights into key drivers and the intensity of particular “spikes” (high blood pressure) should help target opportunities to reduce avoidable episodes of treatment (through the process automated directives for the physician to follow to optimize management).

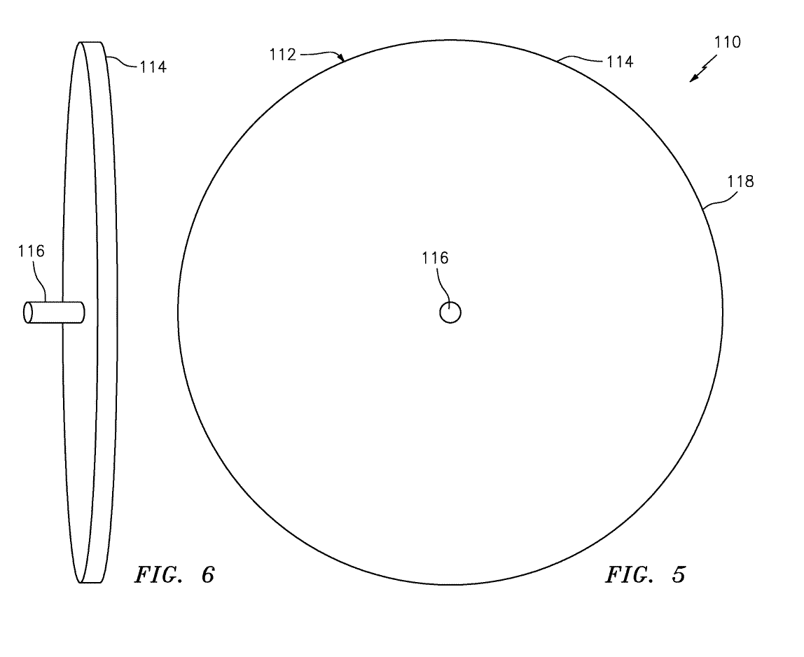

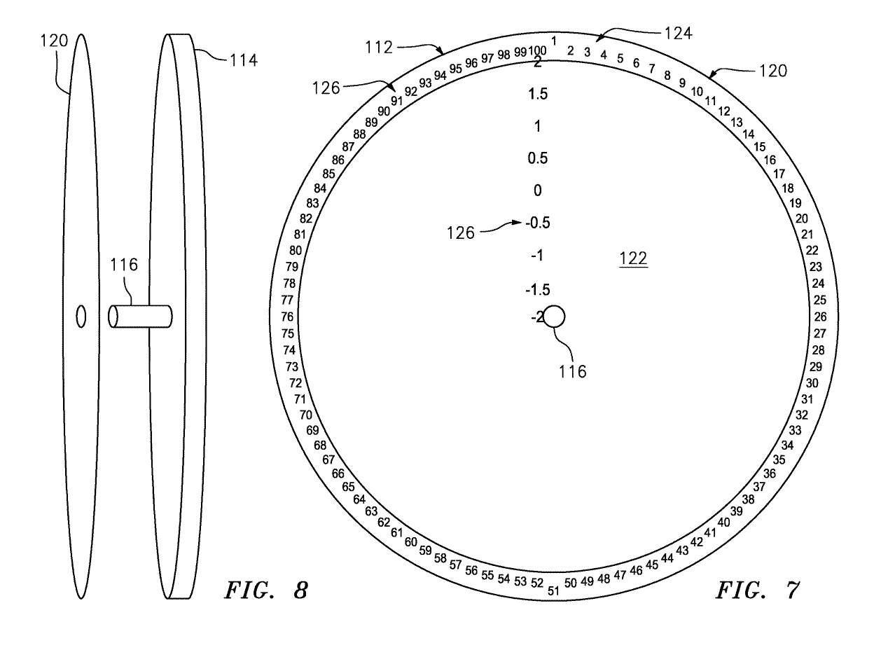

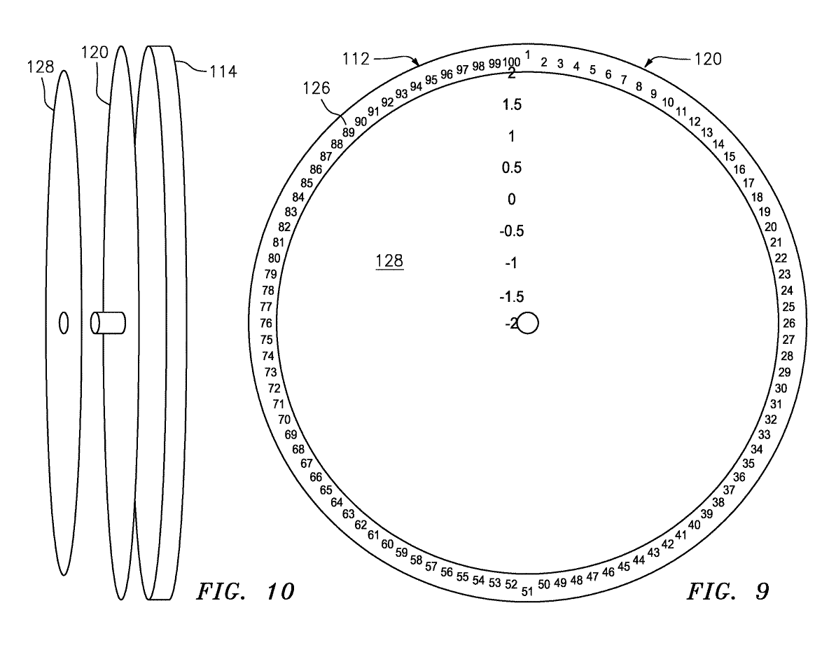

Referring to FIGS. 5 through 15 an alternative exemplary population health management system 110 includes a mechanical process automation device 112, such as a scheduling wheel chart. The mechanical process automation device 112 includes a base 114. The base 114 can be configured as a planar circular disc. The base 114 includes a center 116 and an outer diameter 118. The center 116 is located at the center of the circular shape. The outer diameter 118 is formed around the perimeter of the circular shape. A first rotary sheet 120 can be coupled to the base 114 in a rotary fashion. The first rotary sheet 120 includes a first region 122 proximate the center 116. The first rotary sheet 120 includes a second region 124 adjacent said first region 122 located radially distal from the first region 122.

The first rotary sheet 120 can include indicia 126 that represents criteria sets, similar to the first criteria set 26, second criteria set 28 and third criteria set 38 described above. The rotary sheet 120 or multiple sheets 120, can be used to represent the Engagement Preference Profile, Determinants of Health Member Profile, Fund of Knowledge Profile, Member, Caregiver, Community and Payer Resource Profile, Deviations from Processes, and/or Avoidable Episodes of Treatment. The indicia 126 is shown as numerals, but can be shown as alphabetical and symbol forms as well.

A second rotary sheet 128, as seen in FIGS. 9 through 12 can be included with the device 112. The second rotary sheet 128 can be transparent. The second rotary sheet 128 can include a transparent member profile sheet overlay on top of the first rotary sheet 120 and base 114. This configuration allows for viewing indicia 126 included on both the first rotary sheet 120 and the second rotary sheet 128.

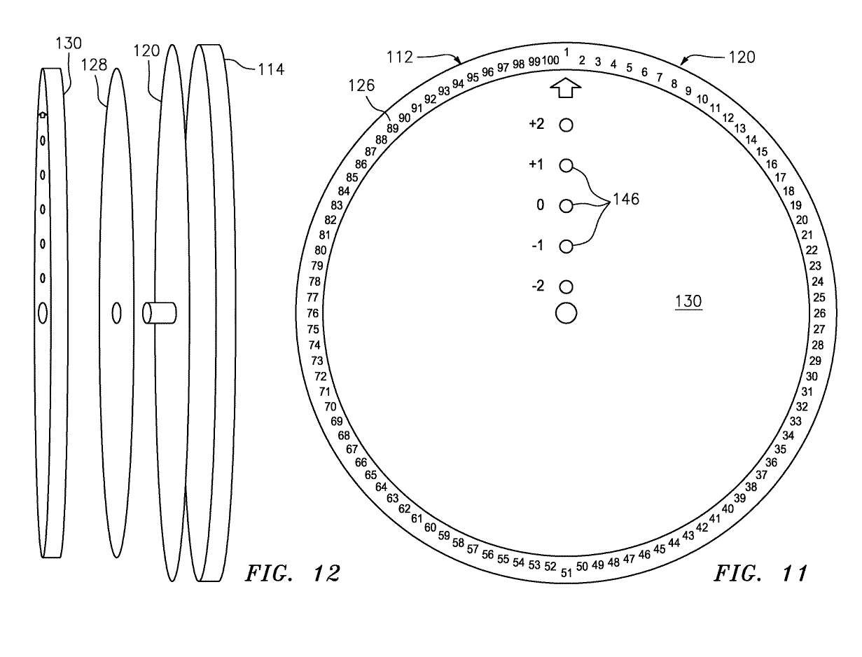

A rotary mask 130, shown in FIGS. 11 and 12, can be coupled on top of the second rotary sheet 128. The rotary mask 130 can include ports or windows 146 that reveal indicia 126 on the second rotary sheet 128 and/or the first rotary sheet 120. The rotary mask 130 can function similarly to the rotary mask 42 described above.

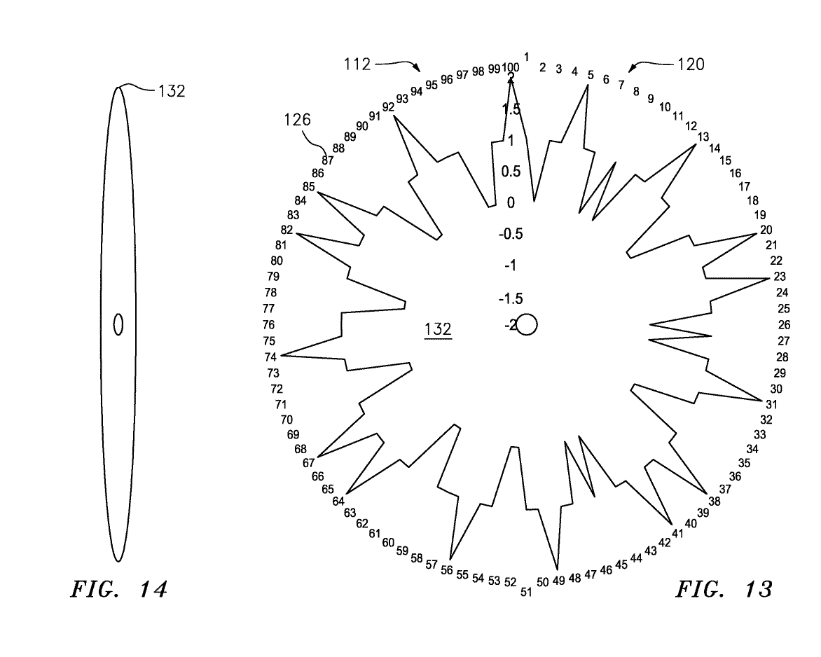

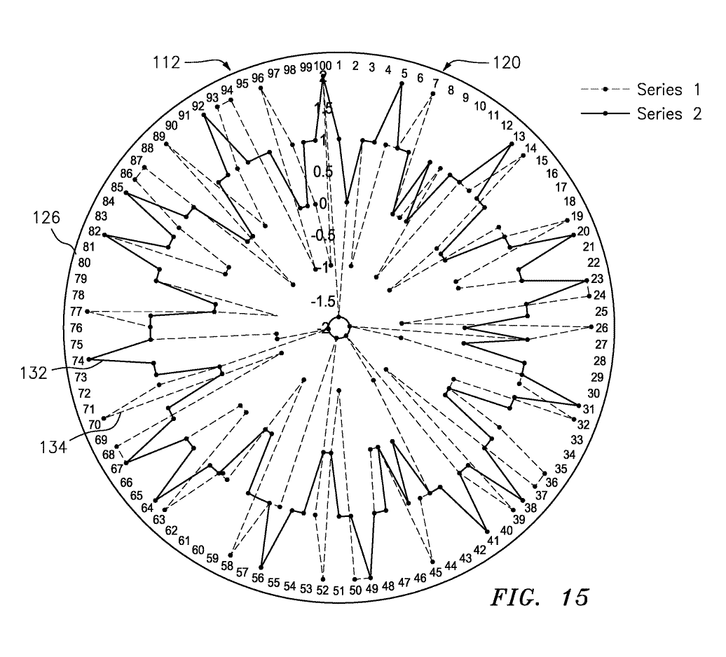

FIGS. 13 and 14 show a spider graph sheet 132 that can be placed over and coupled to the base 114 to cooperate with the first rotary sheet 120 and/or second rotary sheet 128 and rotary mask 130 to provide Determinants of Health member profile on the first rotary sheet 120 with the member specific profile pattern of the spider graph 132.

FIG. 15 shows a second spider graph sheet 134 over the first spider graph sheet 132 that indicates two Determinants of Health member profile sheets overlaid to demonstrate differences in member specific profile patterns.

In an exemplary embodiment, after the health assessment data template 48 has been completed a sample of members with varying annual medical spend can be obtained. Then a proactive collection of the data can be performed to determine what particular area ranges correspond to high vs low costs, which key drivers and spikes are associated with the greatest acute inpatient costs/subacute inpatient costs/specialty drug costs/ER utilization/readmissions. The population health management system 10 can be utilized in prospectively predicted high risk utilizers based on historical trend profiles.

The responses obtained are dialed into the device 12. The device 12 helps to do the following: 1) identifies the best health plan products based on the individual's specific profile, 2) provides addresses and contact information for the providers and services from whom the individual member is most likely to require services during the coming year (doctors, diagnostic and treatment centers, pharmacies, inpatient facilities, 3) offers the individual member contact information and also quality and performance data on all recommended service providers and 4) offers timelines for scheduling an annual wellness visit and preventive comprehensive examination and, where indicated, specialty diagnostic services and 5) based on cohort data supplies the individual member with information on the one year probability of incidents of avoidable episodes of treatment (Urgent Care visits, Emergency room visits, Elective preference-sensitive surgical procedures, unscheduled hospitalizations) from acute flairs of chronic conditions due to suboptimal management of conditions.

Sometime during the first quarter 30, a face to face evaluation of the member is performed. At the time of the face to face evaluation additional collected clinical, behavioral, functional, social, environmental and economic data inputted in the device 12. This data will be used to ensure that the comprehensive preventive examination includes assessment for common conditions associated with hypertension (elevated cholesterol, elevated blood sugar, obesity, smoking critical), prior history of utilization of inpatient, outpatient, medical, behavioral, and social services and evaluation of the signs and symptoms associated with chronic uncontrolled hypertension (hardening of the arteries, enlarged heart, signs of kidney disease) and common care management obstacles to maintaining wellness in similar members (suboptimal care support structure, activities of daily living challenges, inadequate home-proofing to reduce avoidable injuries, visual, auditory, cognitive or functional impairment).

The collected aggregate data is placed in the wheel and using proprietary rules-based logic evidence-based diagnostic services (laboratory studies, diagnostic imaging services, and/or specialty care diagnostic services) are recommended for scheduling.

The system 12 prompts the member, provider and payer to record the scheduled follow-ups. Additionally, the device 12 identifies, community-based, payer-based or care delivery system based resources that have been effective in reducing or eliminating obstacles to the wellness of the member.

Also the device 12 identifies member specific self-directed care management strategies that the member and/or caregiver can utilize to proactively address early signs of loss of wellness to reduce avoidable episodes of treatment.

Finally, the device 12 not only collects data on every planned episode of care to confirm compliance with evidence-based best practices and member adherence to treatment but also every unplanned episode of treatment to identify whether the event was avoidable but within the standard of care, unavoidable but within the standard of care or avoidable and not within the standard of care. This information will help to identify members that fall into the “Extremes” (outliers) category for both the member and for care practices (quality and performance metrics).

The data inputted in the device 12 determines the member's stratification and segmentation of chronic care management (what level of intensity of care management is needed-telephonic, periodic point of contact care management either home-based or in PCP office, or ambulatory intensive care clinic referral).

During the second quarter 32, reference tables will be compiled based on the aggregated data collected on all members in the system. This information will be periodically updated and reported out to members, affiliated providers, care delivery systems and payers.

The members will be able to compare their current wellness status both with their prior status and with that of other members with similar conditions and profiles.

Providers will be able to identify the effectiveness and efficiency of the evaluation and management strategies utilized in their population of members to industry standard performance and quality metrics (including admission and readmission rates, ER and urgent care utilization rates, diagnostic services utilization rates, member medication adherence rates). Providers will also have data reporting on “Extremes” in both the member outcomes and provider management categories and references on best practices for process improvement.

Payers will have up to date provider specific quality and performance data that can drive continuous quality improvement, product design and development and contracting strategies as well and member profiling information for use in better pricing of services, better marketing and sales strategies and improved member satisfaction and retention.

During the third quarter 34, based on the reported information regarding the course of the member's experience through the population health life cycle the member may input data in the device 12 to search for plan designs that better suit the specific needs of the member.

The device 12 can be utilized to assist the member in the selection of the best option during the annual enrollment period.

The provider can use the data to re-stratify the member with regard to risk for potentially avoidable episodes of treatment and if appropriate, designate the member as an “Extreme” and follow the automated processes identified by the device 12 as outlined for intensive ambulatory care management as indicated.

During the fourth quarter 36, the determinants of health data compiled in the first 3 quarters, 30, 32, 34 of the year provides the documentation of the population burden of illness. In the same way the collection of gap in care data over the first 3 quarters provides the completion data for the quality and performance measures of the population (HEDIS).

Additionally, throughout the year encounter data and reconciled claims data can be used to process automate the identification of outlier members in terms of avoidable episodes of treatment and lower cost of care.

The member can receive a preliminary “annual report” chronicling the member's accomplishments around identifying and documenting burden of illness, removing barriers to wellness (closing gaps in care) and efforts to reduce avoidable episodes of treatment.

This information when inputted in the device 12 is indexed to the population of patients managed by the member's (primary care provider) PCP, the practice group of the PCP, comparable practice groups and the payer group.

This information should allow the member to make better decisions regarding health plan choices.

As another example, a contrast between the current state of Health Plan (Medicare Advantage) (MA) for a member can be made with respect to the inventive exemplary population health management system 10.

In this exemplary contrast, three months before the first quarter 30, the Potential Medicare Advantage (MA) member searches available information to choose coverage. By contrast, a Potential Medicare Advantage member searches available information to choose coverage. Upon selecting Health Plan and PCP potential member is sent member specific information.

In the first quarter 30, the Medicare Advantage deadline for switching choices occurs in February. Passive attribution files compilation occurs.

By contrast, in the exemplary population health management system 10, proactive attribution files compilation by pushing information to member and their designated PCP. Once confirmed, the member is sent a determinants-of-health risk assessment to begin the collection of clinical, behavioral, functional, social, environmental and economic determinants of health. The exemplary population health management system 10 uses information to assess where in the scheduling queue to place the member and offer them an appointment. Higher risk members are brought in at the earliest convenience.

During the second quarter 32, in the current state health plan, claims data analysis from the fourth quarter of the prior year for claims paid through the prior quarter (Q1). Member utilization of services in the first quarter occurs without health plan awareness because tracking in claims based and has a 45-90-day lag until claim received, adjudicated as needed, paid and reported.

By contrast, in the exemplary population health management system 10, the member receives a point of contact interview to complete the assessment and a comprehensive preventive examination. The system 10 identifies all of the member's clinical, behavioral, functional, social, environmental and economic determinants of health (causes of loss of wellness or disease) and all of the previously identified process associated with reducing avoidable episodes of treatment for each of the determinants (Gaps in Care). The system 10 tracks that the processes gaps are closed. The system 10 also tracks all episodes of care.

During the third quarter 34, in the current state health plan, claims data analysis from Q1 for claims paid through the prior quarter (Q2). Financial trend data is aggregated and analyzed to determine if the medical cost for the member's cohort has increased, decreased or remained the same. If the trend identifies aberrations a more granular evaluation is performed. Current state health plans have to submit bid for proposed payment for the coming year based on limited claims data.

By contrast, in the exemplary population health management system 10, the system 10 reports on every successful closure of every process gap that can reduce avoidable episodes of treatment using encounter data. Similarly, all episodes of treatment (planned and unplanned) are tracked using encounter data (lead measures) and subsequently reconciled with claims data (45-90 days later). Determinant of health information for the individual members is aggregated for all members attributed to a PCP with comparisons to similar populations. The system 10 reports on every successful closure of every process gap that can reduce avoidable episodes of treatment using encounter data. Similarly, all episodes of treatment (planned and unplanned) are tracked using encounter data (lead measures) and subsequently reconciled with claims data (45-90 days later). Determinant of health information for the individual members is aggregated for all members attributed to a PCP with comparisons to similar populations. The system 10 plan uses 7 ½ months of encounter data and available reconciled claims data to propose coming year payment.

During the fourth quarter 36, in the current conventional health plan, claims data analysis from Q2 for claims paid through the prior quarter (Q3). Financial trend data is aggregated and analyzed to determine if the medical cost for the member's cohort has increased, decreased or remained the same. If the trend identifies aberrations a more granular evaluation is performed. Q4 assessment of the burden of illness and completion of quality and performance measures for the population (HEDIS).

By contrast, in the exemplary population health management system 10, the determinants of health data compiled in the first 3 quarters of the year provides the documentation of the population burden of illness. In the same way the collection of gap in care data over the first 3 quarters provides the completion data for the quality and performance measures of the population (HEDIS). Additionally, throughout the year encounter data and reconciled claims data is used to process automate the identification of outlier members in terms of avoidable episodes of treatment and lower cost of care.

This invention is an improvement on what currently exists taking advantage of the significant advances in the improved efficiencies and lower cost data informatics and data storage to design and develop a system with the resources, processes reporting capabilities to integrate the requisite large volumes of disparate clinical, operational and financial data needed to successfully manage population health in a value-based model of care delivery.

The system will help optimize the effectiveness and efficiency of the management of members with a high burden of illness by having comprehensive clinical, financial and operational data inputs across the continuum of care, aggregating this data with claims data and applying evidence-based algorithms as data is amassed.

The system will predict individuals at risk for developing a high burden of illness.

Additionally, the system will drive lower overall cost by reducing medically unnecessary or avoidable diagnostic and therapeutic interventions,

The system will drive lower overall cost by identifying the value-based alternatives for care delivery and products.

The system will drive lower overall cost by recognizing potential fraud waste and abuse.

The system will drive lower overall cost by optimizing care delivery resource allocation to lower the unit cost of care delivery, avoiding penalties for failing to meet performance and quality benchmarks.

The system will drive lower overall cost by reducing the cost of member acquisition, engagement and retention.

There has been provided a population health management system and device. While the population health management system and device has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A population health management system mechanical process automation device comprising:
a circular base having a center and an outer diameter radially distal from said center; said base including indicia; said indicia comprising:
a first criteria set concentrically located on said base in a first region proximate said center; wherein said first criteria set comprises discrete health management actionable topics spaced concentrically apart in said first region;
a second criteria set concentrically located on said base in a second region radially outward from said first region, said second criteria comprising quarterly calendar sets spaced concentrically apart as quarters in said second region;
a third criteria set concentrically located on said base in a third region radially outward from said second region and proximate said outer diameter, said third criteria set comprising a plurality of population health information data symbols; and
at least one rotary mask coupled to said base and configured to rotate about said center, said at least one rotary mask having a circular shape configured to conceal a portion of said indicia and reveal a portion of said indicia responsive to rotation of said at least one rotary mask.

2. The population health management system according to claim 1, wherein said mechanical process automation device comprises a scheduling wheel chart.

3. The population health management system according to claim 1, wherein said discrete health management actionable topics comprise at least one of evaluation, education, empowerment, extremes, engagement, and enrollment.

4. The population health management system according to claim 3, wherein said evaluation is based on the collection of structured and non-structured clinical, behavioral, functional, pharmaceutical, socioeconomic, utilization and resource allocation data.

5. The population health management system according to claim 1, wherein said quarterly calendar sets comprise a first quarter of a year, a second quarter of said year, a third quarter of said year and a fourth quarter of said year.

6. The population health management system according to claim 1, wherein said plurality of population health information data symbols represent population health information selected from the group consisting of burden of illness, gap in care closure, plan of care completion, member attribution update and the like.

7. The population health management system according to claim 1, wherein said mechanical process automation device is configured to guide a user to systematically chronologically implement the health management system to deliver health care to a population enrolled within the health management system.

8. A process for utilizing a population health management mechanical process automation device, said process comprising:
revealing indicia concentrically located on a circular base of the mechanical process automation device, said base having a center and an outer diameter radially distal from said center; said indicia including at least one criteria set;
rotating a circular rotary mask coupled to said base and configured to rotate about said center;
concealing a portion of said indicia responsive to rotation of said rotary mask;
revealing a portion of said indicia responsive to rotation of said rotary mask;
collecting data related to a first criteria set concentrically located on said base in a first region proximate said center, said collecting data step being initiated based on a second criteria set concentrically located on said base in a second region radially outward from said first region; and
collecting data related to a third criteria set concentrically located on said base in a third region radially outward from said second region and proximate said outer diameter.

9. The process according to claim 8, wherein said first criteria set comprises discrete health management actionable topics spaced concentrically apart in said first region of said base.

10. The process according to claim 9, wherein said discrete health management actionable topics comprise at least one of evaluation, education, empowerment, extremes, engagement, and enrollment.

11. The process according to claim 8, wherein said second criteria comprises quarterly calendar sets spaced concentrically apart as quarters in said second region.

12. The process according to claim 11, wherein said quarterly calendar sets comprise a first quarter of a year, a second quarter of said year, a third quarter of said year and a fourth quarter of said year.

13. The process according to claim 8, wherein said third criteria set comprises a plurality of population health information data symbols.

14. The process according to claim 13, wherein said plurality of population health information data symbols represent population health information selected from the group consisting of burden of illness, gap in care closure, plan of care completion, member attribution update and the like.

15. The process according to claim 8, further comprising:
guiding a user to systematically chronologically implement the health management system to deliver health care to a population enrolled within the health management system.

16. The process according to claim 10, further comprising:
employing a health assessment data template to collect data related to said discrete health management actionable topics.

17. The process according to claim 16, wherein the health assessment data template includes inquiries with corresponding answers to said inquiries.

18. The process according to claim 17, further comprising:
assessing the answers utilizing a color code rank value assigned to the answers, wherein the color code rank value provides a visual cue for the assessment data template.

19. The process according to claim 18, further comprising:
converting said color code rank value into numerical values; and
converting said numerical values into a graphic format.

20. The process according to claim 19, wherein said graphic format comprises a spider graph.
